(19) United States
(12) Patent Application Publication
(10) Pub. No.: US 2005/0081723 A1
(43) Pub. Date: Apr. 21, 2005

(54) Reamer structure of a juicer

(76) Inventor: Kuo-I Lin, Taipei Hsien (TW)

Correspondence Address: Kuo-I Lin, 235 Chung - Ho, Box 8-24, Taipei, TW

(21) Appl. No.: 11/006,227

(22) Filed: Dec. 7, 2004

(30) Foreign Application Priority Data
Apr. 16, 2002 (TW) 093205931

(51) Int. Cl. A23N 1/00; A23L 1/00

(52) U.S. Cl. 99/501

(57) ABSTRACT

A reamer structure of a juicer for extracting juice from a whole fruit comprises an opening provided with a plurality of annularly arranged teeth and a base member with a polygonal locking receptacle for securing an upstanding spindle from a driving unit of a juicer, whereby cutting a fruit in halves is not needed. The reamer is further provided with a plurality of claw shaped projections for extracting juice from fruit flesh. The reamer further includes at least two oppositely and horizontally scrapers extended from its base. The reamer can also be integrally formed with a strainer of a juicer.

### FIELD OF THE INVENTION

The present invention relates to juicers, more particularly to a reamer structure of a juicer for more effective fruit juice extraction.

### BACKGROUND OF THE INVENTION

Juicers of the prior art utilize a driving mechanism, comprising a electric motor and a gear set, for driving a reamer to rotate, on which a half fruit is pressed so that a plurality of claw shaped projections on the reamer can sweep through the fruit flesh 74 for juice extraction. The extracted juice flows in the radial direction on the reamer and is collected within a container under the reamer. It is necessary to cut a fruit into halves before the fruit is processed by juicers of the prior art.

Because of the necessity of fruit cutting, the conventional juice extraction process is dangerous for a child to operate, and an amount of fruit juice will be lost. Further, the use of a knife and a cutting board brings extra cleaning work.

Referring to FIG. 9, the major problem of the juicers of the prior art is that a half citrus fruit is easy to get slipped on a reamer 6 having a plurality of claw shaped projections 61. As shown in FIGS. 10 and 11, a citrus fruit 7 usually has a firm core axis 73, which is where the fruit flesh 74 converges. After the citrus fruit is cut perpendicularly across the core axis 73 into two halves, we can see on a cross section that fruit segments 72 extend in a radial fashion from the core axis 73. Since the firm core axis 73 is pressed against the apex of the juicing cone 6 when a half citrus fruit is engaged with the reamer 6 for juice extraction, the core axis 73 is easy to slip off the apex, causing a misalignment of the half citrus fruit with the reamer 6.

The structure of the reamer 6 having claw shaped projections 61, which has an arcuate conic surface and a hard apex, causes an unstable configuration as a half fruit is press against the reamer 6. Because of the firm core axis 73 and the radial interfaces between the fruit segments 72, a half of the citrus fruit 7 is easy to slip off and becomes misaligned with the reamer 6.

### SUMMARY OF THE INVENTION

Accordingly, the objective of the present invention is to provide a reamer structure of a juicer having the effects as follows.

1. During the juice extraction, the core axis portion of the fruit is constrained in a center tube of the reamer so that the core axis is separated from the fruit segments and the core axis can keep steady.

2. The procedure of cutting a fruit in halves before the juice extraction is not needed.

3. Because of the omission of cutting, extra cleaning work for a knife and a cutting board is saves.

4. Therefore, a juicer with the reamer is safe for children to operate.

To achieve above object, the present invention provides a reamer structure of a juicer which comprising: an opening formed on a top portion of said reamer having a sharp cutting edge for engaging a fruit, said cutting edge being further provided with a plurality of annularly arranged teeth; a plurality of claw shaped projections extending downward from said opening and along a central axis of said reamer; and a base member integrally form on a lower portion of said reamer, said base member having a polygonal locking receptacle for securing an upstanding spindle from a driving unit of said juicer.

The juicer comprises a base, a waterproof head, a container, a strainer and said reamer, wherein said base further comprises a driving unit with an upstanding spindle that is connected with said waterproof head on a free end thereof, and wherein a bottom end of said reamer is further provided with a plurality of flexible hook pieces extendable into a central hole of said strainer for securing with said base, whereby said spindle can go through said container and said strainer and get connected with said reamer.

A bottom portion of said reamer further includes at least two oppositely and horizontally extended scrapers. The juicer comprises a base, a waterproof head, a container, a strainer and said reamer, wherein said strainer is integrally formed with said reamer, wherein said base further comprises a driving unit with an upstanding spindle that is connected with said waterproof head on a free end thereof, and wherein a bottom end of said reamer is further provided with a plurality of flexible hook pieces extendable into a central hole of said strainer for securing with said base, whereby said spindle can go through said container and said strainer and get connected with said reamer. Each of said teeth is an arc shaped plate of sharp cross-section.

The various objects and advantages of the present invention will be more readily understood from the following detailed description when read in conjunction with the appended drawings.

### BRIEF DESCRIPTION OF THE DRAWINGS

FIG. 1 is an exploded perspective view of the first preferred embodiment according to the present invention.

FIG. 2 is a perspective view of the first preferred embodiment according to the present invention.

FIG. 3 is a perspective view of the first preferred embodiment of the present invention, wherein the reamer is separated.

FIG. 4 is a side cross-sectional view of the reamer of the first preferred embodiment according to the present invention.

FIG. 5 is a side cross-sectional view of the first preferred embodiment according to the present invention.

FIG. 6 is an exploded perspective view of the second preferred embodiment according to the present invention.

FIG. 7 is a perspective view of the second preferred embodiment according to the present invention.

FIGS. 8A and 8B are two cross-sectional views of a half citrus fruit being processed with the reamer of the present invention.

FIG. 9 is side cross-sectional view of a juicer of the prior art.

FIGS. 10 and 11 is two cross-sectional views of a half citrus fruit being processed with the juicer of the prior art.

### DETAILED DESCRIPTION OF THE PREFERRED EMBODIMENTS

The First Preferred Embodiment

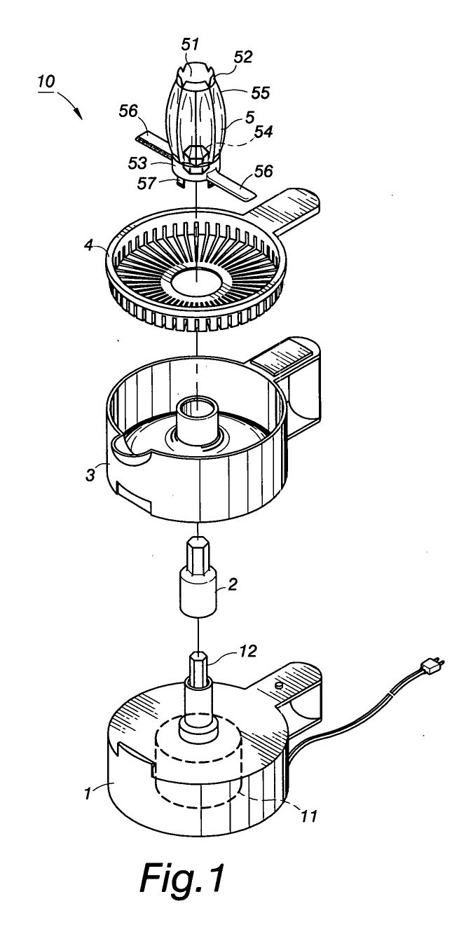

Referring to FIG. 1, a juicer 10 associated with the present invention comprises a base 1 including a driving unit 11 and a spindle 12, a waterproof head 2 mounted on the spindle 12, a juice collecting container 3 mounted on the base 1, a strainer 4 stacked over the container 3 and a reamer 5 mounted on the waterproof head 2 and engaged with the strainer 4. The reamer 5 further comprises an opening 51 for retaining the core axis of a citrus fruit and for separating the core axis from the fruit segments. The opening 51 is provided with teeth 52 around the sharp cutting edge thereon for a more effective cutting effect.

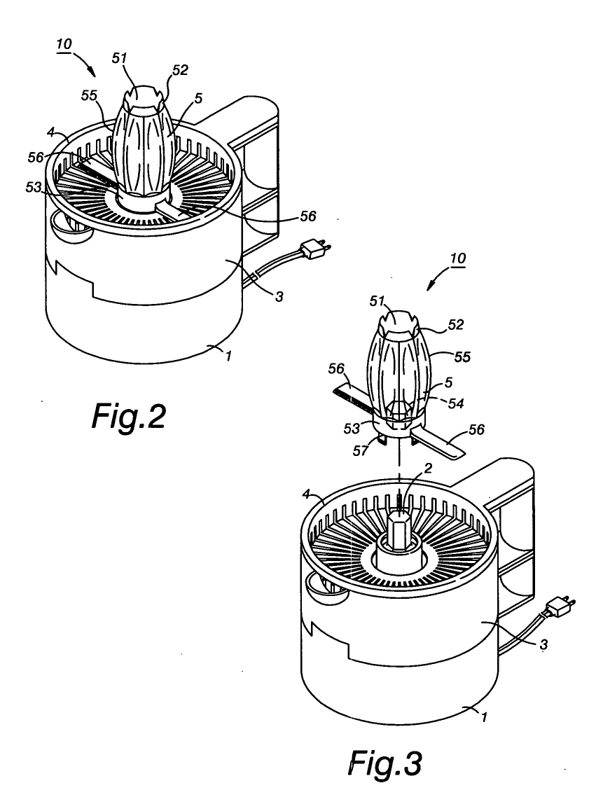

FIG. 2 is a perspective view of the first preferred embodiment after the above parts are assembled. FIG. 3 is a perspective view of the first preferred embodiment, wherein the reamer 5 is separated.

The driving unit 11 further includes a weight-sensing member, so that the motor can be activated once an appreciable downward force is applied on the base 1; the motor stops automatically if the load is lifted. Since the motor and the associated gear set are of the prior art, the principle of the driving unit 11 will be specified no more. As the spindle 12 rotates (driven by the driving unit 11), the waterproof head 2 and the reamer 5 rotates synchronically. The waterproof head 2 goes through a central tube of the container 3 and engaging the reamer 5, and the strainer 4 is attached onto the container 3, a central hole of which is aligned with the central tube of the container 3.

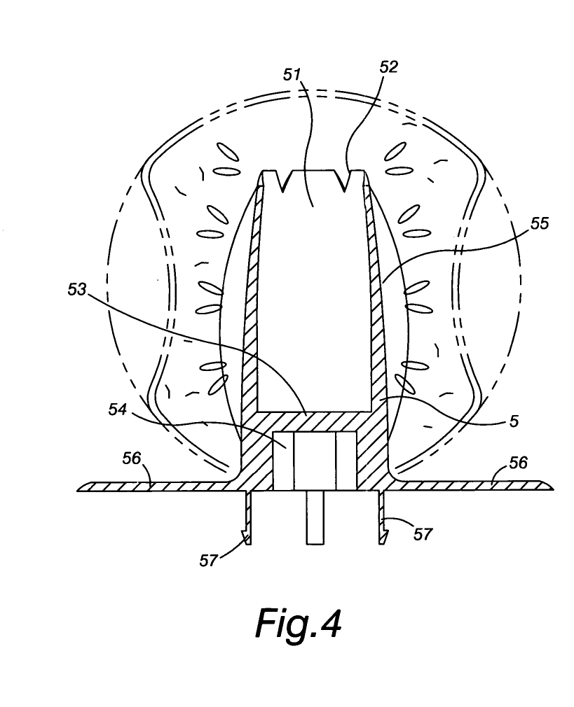

Referring to FIGS. 3 and 4, the reamer 5, made of plastic, has a top portion with an opening 51 provided with a plurality of annularly arranged teeth 52. Each of the teeth 52 is an arc shaped plate having a sharp cross-section. The reamer 5 is further provided with a plurality of claw shaped projections 55, which are extended downward along the axis of the reamer 5 and for enhancing the frictional effect between the reamer 5 and the fruit flesh of a fruit. The bottom portion of the reamer 5 is a base member 53 that closes the hollow space under the opening 51. On the other side of the base member 53, a locking receptacle 54 with polygonal inner wall for the engagement of the waterproof head 2 with polygonal outer wall is provided. Further, two scrapers 56 are extended from the bottom side of the base member 53, in opposite directions. The scrapers 56 situate slightly above the strainer 4 for scraping away the fruit pips and coarse materials thereon. Further, the bottom face of the base member 53 is provided with a plurality of downwardly extended flexible hook pieces 57, so that, by inserting the hook pieces 57 into the central hole, the reamer 5 can be rotationally mounted on the strainer 4. Since the strainer 4 is secured with the container 3, the reamer 5 can rotate with respect to the strainer 4.

The opening 51 has the smallest diameter along the reamer 5. The base member 53 has the second smallest diameter, and the portion where the claw shaped projections 55 distributed has the largest diameter. In this preferred embodiment, the diameter of the opening 51 ranges from 1 to 1.5 cm, the diameter of the base member 53 is about 2 cm, and the diameter of the portion having claw shaped projections 55 can be above 2.5 cm.

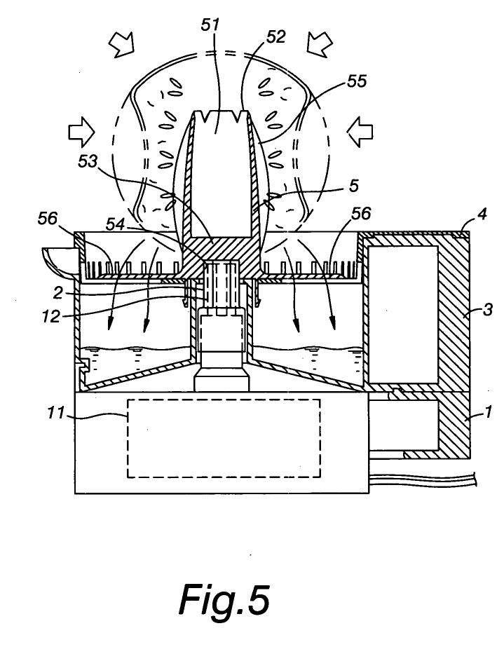

As shown in FIG. 5, to operate a juicer 10 having the reamer 5, a user aligns the stem portion on the surface of a fruit with the opening 51 of the reamer 5 and presses down so that the teeth 52 of the reamer 5 can cut into the fruit. After the fruit is mounted, the weight-sensing unit of the driving unit 11 turns on the motor, thereby the motor driving the spindle 12 and the waterproof head 2 thereon. As the user continues to push the fruit, the reamer 5 penetrates deeper into the fruit, whereby the claw shaped projections 55 extract juice from the fruit flesh. The user can squeeze the fruit laterally so that more juice can be extracted. The juice passes through the strainer 4 and gets collected within the container 3, during which fruit pips and coarse elements are stayed in the strainer 4. The scrapers 56 sweep away the fruit pips and coarse elements on the strainer 4 so that the slits on the strainer 4 will not get blocked.

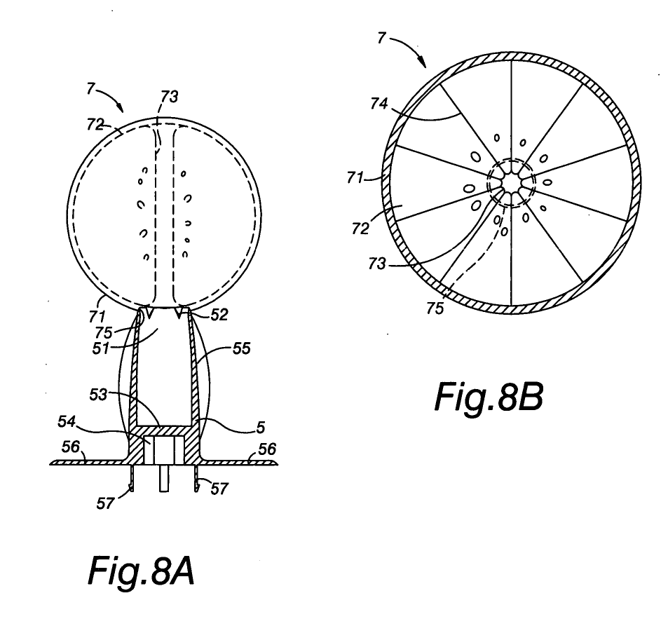

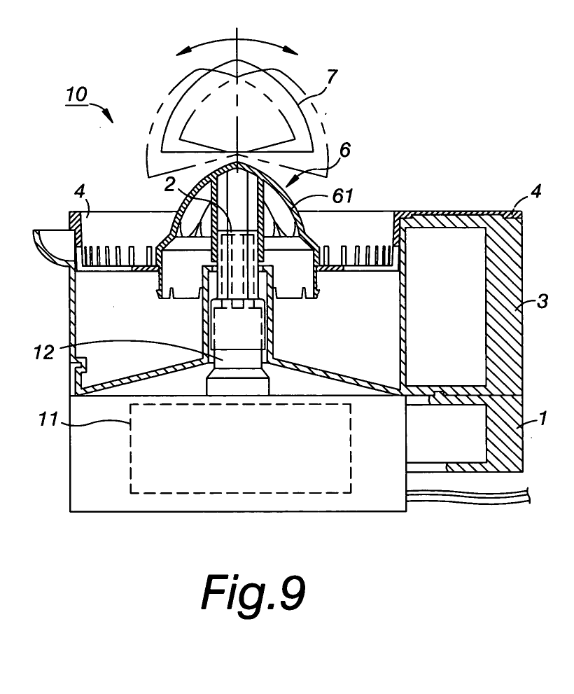

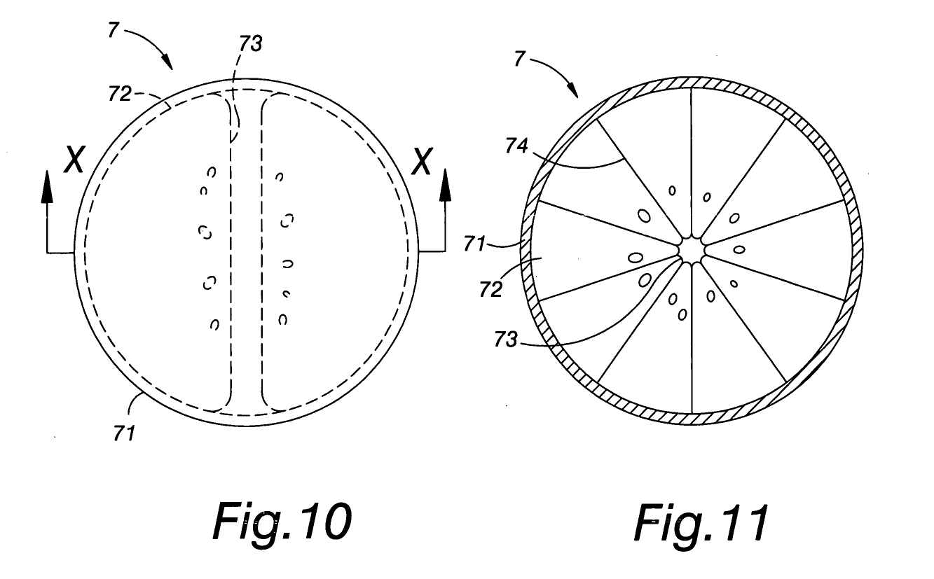

As shown in FIG. 8, although a part of the fruit is retained in the hollow space under the opening 51 of the reamer 5, this will not significantly reduce the amount of juice extractable from the fruit, since the part of the fruit in the reamer 5, which is the core axis portion, contains the least amount of juice. To take the fruit away from the juicer after the juice extraction, simply lift the fruit from the reamer 5. Since the core axis portion has never separated from the fruit, it will leave the juicer at the same time. Therefore, cutting a fruit into halves is not necessary using the present invention.

The Second Preferred Embodiment

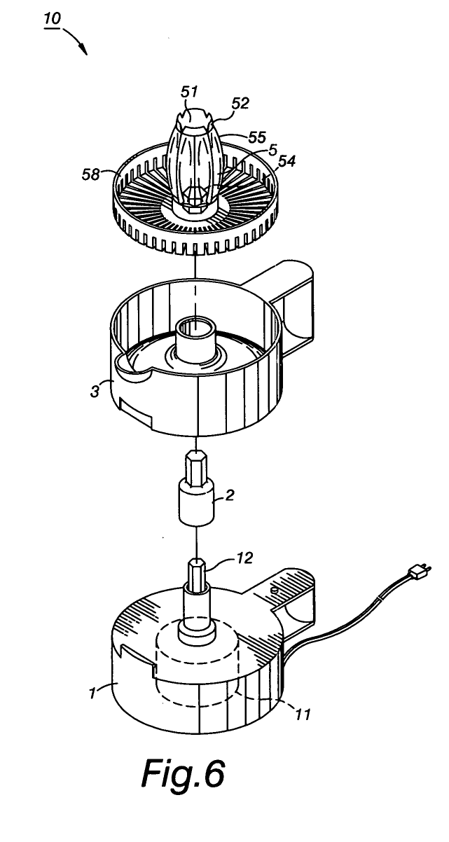

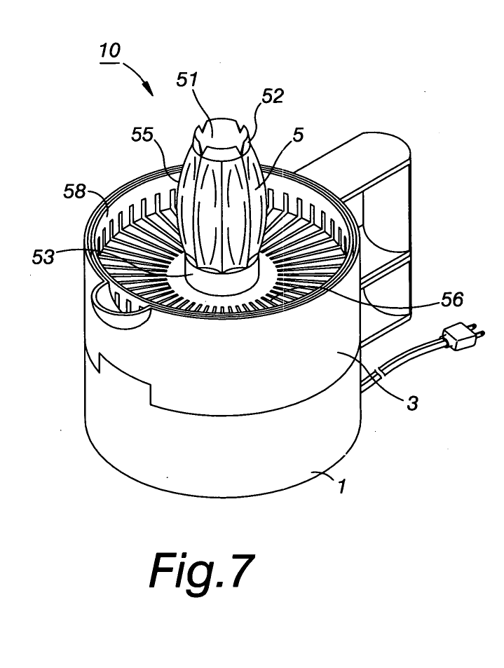

Referring to FIGS. 6 and 7, the second preferred embodiment of the present invention has a strainer 58 integrally formed on the bottom portion of a reamer 5, so that the scrapers 56 of the first preferred embodiment are not needed, since the strainer 58 rotates synchronically with the reamer 5 and therefore the fruit pips and other coarse residues are continuously shaken away from the slits.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

1. A reamer structure of a juicer, comprising:
an opening formed on a top portion of said reamer having a sharp cutting edge for engaging a fruit, said cutting edge being further provided with a plurality of annularly arranged teeth;
a plurality of claw shaped projections extending downward from said opening and along a central axis of said reamer; and
a base member integrally form on a lower portion of said reamer, said base member having a polygonal locking receptacle for securing an upstanding spindle from a driving unit of said juicer.

2. The reamer structure of a juicer of claim 1 wherein said juicer comprises a base, a waterproof head, a container, a strainer and said reamer, wherein said base further comprises a driving unit with an upstanding spindle that is connected with said waterproof head on a free end thereof, and wherein a bottom end of said reamer is further provided with a plurality of flexible hook pieces extendable into a central hole of said strainer for securing with said base, whereby said spindle can go through said container and said strainer and get connected with said reamer.

3. The reamer structure of a juicer of claim 1 wherein a bottom portion of said reamer further includes at least two oppositely and horizontally extended scrapers.

4. The reamer structure of a juicer of claim 1 wherein said juicer comprises a base, a waterproof head, a container, a strainer and said reamer, wherein said strainer is integrally formed with said reamer, wherein said base further comprises a driving unit with an upstanding spindle that is connected with said waterproof head on a free end thereof, and wherein a bottom end of said reamer is further provided with a plurality of flexible hook pieces extendable into a central hole of said strainer for securing with said base, whereby said spindle can go through said container and said strainer and get connected with said reamer.

5. The reamer structure of a juicer of claim 4 wherein each of said teeth is an arc shaped plate of sharp cross-section.
